(19) United States
(12) Patent Application Publication
(10) Pub. No.: US 2011/0050731 A1
(43) Pub. Date: Mar. 3, 2011

(54) System and method of adjusting zoom factors of display area and display contents

(75) Inventors: Chaucer Chiu, Taipei (TW); Tao Zhou, Shanghai (CN)

(73) Assignee: INVENTEC CORPORATION, Taipei (TW)

(21) Appl. No.: 12/591,619

(22) Filed: Nov. 25, 2009

(30) Foreign Application Priority Data
Sep. 3, 2009 (TW) 098129727

(51) Int. Cl. G09G 5/00

(52) U.S. Cl. 345/660

(57) ABSTRACT

This specification discloses system and method of adjusting the zoom factors of display area and display contents. A zoom region around the cursor is zoomed by the area zoom factor, rendering an area zoomed image for display. The user can then adjust the zoom of the display area. The area zoomed image is zoomed by the contents zoom factor, rendering a contents zoomed image for display. The user can then zoom the display contents. The system thus achieves the effects of zooming the display area and display contents.

### BACKGROUND OF THE INVENTION

1. Field of the Invention

The invention relates to system and method that adjust zoom factors and, in particular, to system and method of adjusting the zoom factors of display area and display contents, respectively.

2. Related Art

With great progress in electronic technology, various kinds of auxiliary tools have been developed. For example, when a user starts a default magnifier in an operating system (OS), the OS opens a display area at the very top of the screen. The image around the cursor is immediately magnified in the opened display area according to the zoom factor designated by the user. The user can then view the magnified image and operate the OS.

However, the above-mentioned magnified area is limited to the top of the screen. This is not convenient for the user to operate. Therefore, some people propose a kind of magnifier with a movable display area for the convenience of operation. Nevertheless, the above-mentioned magnifiers with fixed and movable display area do not allow the user to adjust the display area.

Besides, some people propose the function of local magnification. That is, after setting a magnification region, the region and the contents therein are magnified and displayed in a display area. The magnification region and the contents therein are magnified by the same zoom factor and displayed. The advantage is that the user can operate on the magnified contents. However, such a magnification function does not support further magnification of the contents in the magnification region.

Therefore, the display areas of the above-mentioned magnifiers or the magnification function either do not allow further adjustment or only support one magnification setting when starting it and magnifying the selected magnification region according to the designated zoom factor. They do not have the function of adjusting the display area in real time. In addition, the above-mentioned magnifiers or magnification function only support one magnification. In other words, they can only magnify the display contents or magnify the contents in the selected magnification region. In this case, both the magnification region and the contents therein are magnified by the same zoom factor. Therefore, current magnifiers and magnification functions do not support comprehensive magnifying effects for the display area and display contents.

In summary, the prior art always has the problem that the display area and display contents cannot be zoom independently. It is therefore imperative to provide a satisfactory solution.

### SUMMARY OF THE INVENTION

In view of the foregoing, the invention proposes system and method that adjust the zoom factors of display area and display contents.

The disclosed system of adjusting the zoom factors of display area and display contents includes: an extracting module, a zooming module, a displaying module, a receiving module, and an adjusting module.

The extracting module extracts the screen image as an original image. The zooming module takes the cursor position as the center and zooms the original image according to an area zoom factor, rendering an area zoomed image. It further zooms the area zoomed image according to a contents zoom factor, rendering a contents zoomed image. The displaying module shows the display area according to the shape and size of the area zoomed image. It then displays the area zoomed image and contents zoomed image in the display area. The receiving module receives area adjusting parameter or contents adjusting parameter. When receiving the area adjusting parameter, the adjusting module sets the area zoom factor according to the area adjusting parameter. When receiving the contents adjusting parameter, the adjusting module sets the contents zoom factor according to the contents adjusting parameter.

The disclosed method of adjusting the zoom factors of display area and display contents includes the steps of: extracting the screen image as an original image; taking the cursor position as the center of a zoom region and zooming the zoom region of the original image according to an area zoom factor as an area zoomed image; showing a display area according to the shape and size of the area zoomed image and displaying the area zoomed image in the display area; zooming the area zoomed image according to a contents zoom factor as a contents zoomed image; displaying the contents zoomed image in the display area; receiving area adjusting parameter or contents adjusting parameter; setting an area zoom factor according to the received area adjusting parameter; and setting a contents zoom factor according to the received contents adjusting parameter.

The system and method disclosed above differ from the prior art in that the invention magnifies the zoom region around the cursor position of the original image into the area zoomed image according to the area zoom factor. The area zoomed image is further zoomed into the contents zoomed image according to the contents zoom factor. The invention uses the area zoom factor and the contents zoom factor to magnify the display area and the display contents, respectively. Therefore, the invention provides comprehensive zoom effects for the display area and display contents.

Using the above-mentioned technique, the invention simultaneously achieves the goals of zooming display area and display contents.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed system that adjusts the zoom factors of display area and display contents;

FIG. 2 is a flowchart of the disclosed method that adjusts the zoom factors of display area and display contents;

FIG. 3A is a schematic view of the screen image for adjusting the zoom factors of display area and display contents;

FIG. 3B is a schematic view of the display area according to the invention;

FIG. 3C is a schematic view of the contents zooming according to the invention; and

FIG. 3D is a schematic view of the area zooming according to the invention.

### DETAILED DESCRIPTION OF THE INVENTION

The present invention will be apparent from the following detailed description, which proceeds with reference to the accompanying drawings, wherein the same references relate to the same elements.

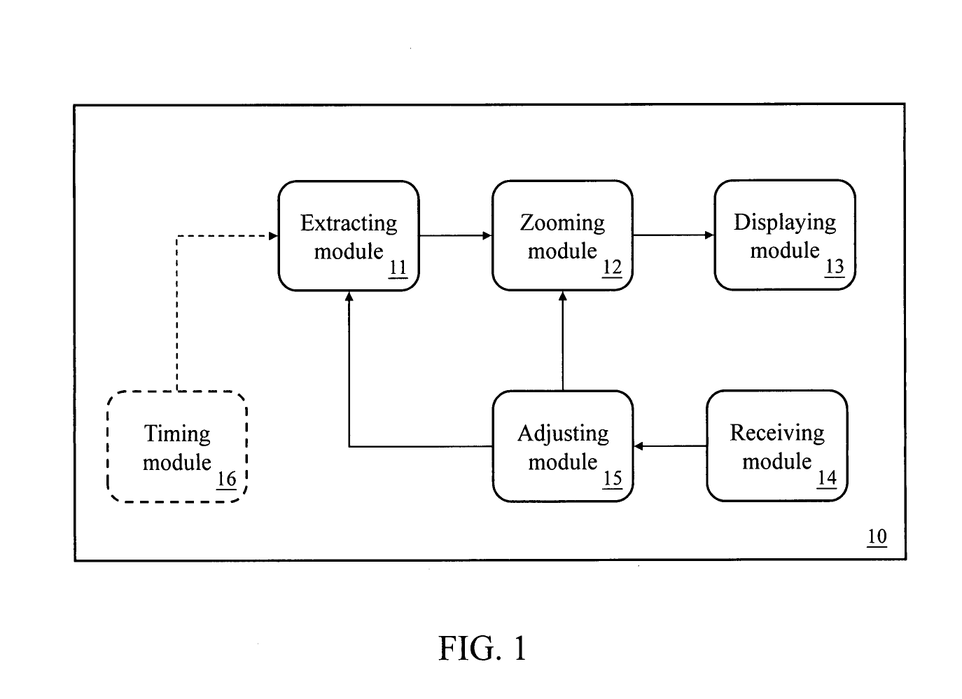

The following paragraphs first describe the disclosed system of adjusting the zoom factors of display area and display contents. Please refer to FIG. 1, which is a block diagram of the system of adjusting the zoom factors of display area and display contents according to the invention. The zoom factor adjusting system 10 includes: an extracting module 11, a zooming module 12, a displaying module 13, a receiving module 14, and an adjusting module 15.

When the invention starts, the zoom factor adjusting system 10 first extracts the screen image as an original image using the extracting module 11. Since the technology of extracting the screen image is very mature, it is not further described herein. Any existing screen extraction technology can be used in the extracting module 11 of the invention.

Afterwards, the zooming module 12 of the zoom factor adjusting system 10 zoom the image in the zoom region of the original image into an area zoomed image according to the area zoom factor. The zoom region centers at the cursor position. That is, the zooming module 12 of the zoom factor adjusting system 10 first finds the position of the cursor on the original image. The cursor position is then taken as the center. The zooming module 12 extracts the zoom region of the original image accordingly. Finally, the zooming module 12 zooms the zoom region of the original image into the area zoomed image according to the area zoom factor.

The above-mentioned zoom region can be a geometrical shape, such as rectangle, circle, etc. The zoom region shape can be predetermined by the zoom factor adjusting system 10 or set by the user. The zoom region size can also be predetermined by the zoom factor adjusting system 10 or set by the user. That is, the size of the zoom region can be adjusted. The image zooming technique used by the zooming module 12 on the image can be interpolation, extrapolation, vector method, etc. The image zooming technique is very mature and is not further described herein. Please refer to existing image zooming techniques.

More explicitly, suppose the size of the original image extracted by the extracting module 11 of the zoom factor adjusting system 10 is “640×480”. The cursor position is assumed to be (200,200), and the zoom region is a circle of radius “50”. The zooming module 12 of the zoom factor adjusting system 10 first finds the corresponding cursor position (200,200) in the original image, which is exactly (200,200) in the original image. A circular region of radius “50” is obtained with (200,200) on the original image as the center. The coordinate sets of the extracted zoom region are then (250,200), (249,201), (248,202), . . . , (201,249), (200,250), (199,249), . . . , (151,201), (150,200), (151,199), . . . , (199,151), (200,150), (201,151), . . . , (248,198), and (249,199). The zooming module 12 then zooms the image enclosed by the above-mentioned coordinate sets of the original image according to the area zoom factor. This is only one example and should not be used to restrict the scope thereof.

After the zooming module 12 of the zoom factor adjusting system 10 zooms the zoom region centered at the cursor position in the original image according to the area zoom factor into the area zoom image, the displaying module 13 of the zoom factor adjusting system 10 shows the display area according to the shape and size of the area zoomed image. The area zoomed image is shown in the display area.

Afterwards, the zooming module 12 of the zoom factor adjusting system 10 zooms the area zoomed image into a contents zoomed image according to the contents zoom factor.

Afterwards, the displaying module 13 of the zoom factor adjusting system 10 shows the contents zoomed image in the display area.

It should be noted that the contents zoom factor is normally set as “1”. When the zooming module 12 of the zoom factor adjusting system 10 zooms the area zoomed image into the contents zoomed image according to the contents zoom factor, the area zoomed image does not change because the contents zoom factor is set as “1”. That is, the contents zoomed image is the same as the area zoomed image. This prevents the display difference between the area zoomed image and the contents zoomed image when the zoom factor adjusting system 10 starts.

In addition, when the displaying module 13 of the zoom factor adjusting system 10 shows the displaying area according to the shape and size of the area zoomed image, the display area replaces the cursor control. That is, the display area moves with the mouse, and its central position is the cursor position. The operating function of the mouse is temporarily disabled. It is enabled again when the zoom factor adjusting system 10 stops.

In the case, as the operating function of the mouse is temporarily disabled, the user cannot use the mouse to perform any operation. When the user hits a key or key combination on the keyboard or clicks a key or key combination on the mouse, the receiving module 14 of the zoom factor adjusting system 10 receives the area adjusting parameter or contents adjusting parameter.

When the user operates to trigger a specific operation event, it is received by the receiving module 14 of the zoom factor adjusting system 10. The specific operation event corresponding to the area adjusting parameter and the contents adjusting parameter can be predetermined by the zoom factor adjusting system 10 or set by the user. This is only one example of the invention and should not be used to restrict the scope thereof.

More explicitly, a keyboard key event is pressing a single keyboard key, such as pressing the single “E” key. A keyboard key combination event is an operation of depressing at least two keys simultaneously, such as pressing the keys “Ctrl+Alt+↑” simultaneously. A mouse key combination event is an operation of pressing mouse keys simultaneously. For example, one can simultaneously press the left key of the mouse and roll the roller thereof. A keyboard mouse key combination is an operation of simultaneously pressing a keyboard key and a mouse key. For example, it is an operation of simultaneously pressing the key “E” and rolling the roller of the mouse. The above-mentioned examples should not be used to restrict the scope of the invention.

When the user triggers a specific operation event following the above-mentioned operation, the zoom factor adjusting system 10 receives the area adjusting parameter or contents adjusting parameter corresponding to the specific operation event. It means that user wants to operate the zoom factor adjusting system 10. According to the area adjusting parameter or contents adjusting parameter received by the receiving module 14, the adjusting module 15 of the zoom factor adjusting system 10 adjusts the zoom factor.

After the receiving module 14 of the zoom factor adjusting system 10 receives the area adjusting parameter, the adjusting module 15 of the zoom factor adjusting system 10 sets the area zoom factor according to the area adjusting parameter. After the area zoom factor is reset, the zooming module 12 of the zoom factor adjusting system 10 zooms the zoom region centered at the cursor position of the original image into a new area zoomed image. The displaying module 13 of the zoom factor adjusting system 10 displays the display area according to the shape and size of the area zoomed image and displays the area zoomed image in the display area. This achieves the effect of adjusting the zoom of the display area.

After the receiving module 14 of the zoom factor adjusting system 10 receives the contents adjusting parameter, the adjusting module 15 of the zoom factor adjusting system 10 sets the contents zoom factor according to the contents adjusting parameter. After the contents zoom factor is reset, the zooming module 12 of the zoom factor adjusting system 10 zooms the area zoomed image into a new contents zoomed image according to the new contents zoom factor. The displaying module 13 of the zoom factor adjusting system 10 displays the contents zoomed image in the display area. This achieves the effect of adjusting the zoom of the display contents.

Besides, the disclosed zoom factor adjusting system 10 can further includes a timing module 16 for counting the extraction time. Each time the timing module 16 of zoom factor adjusting system 10 counts one extraction time, the extracting module 11, the zooming module 12, and the displaying module 13 of the zoom factor adjusting system 10 are re-executed. That is, the screen image is extracted again as the original image. A new area zoomed image or contents zoomed image is then obtained and displayed again.

When the extraction time interval of the timing module 16 of the zoom factor adjusting system 10 is set shorter, the area zoomed image or contents zoomed image obtained by the zoom factor adjusting system 10 is updated more frequently. The extraction time can be predetermined by the zoom factor adjusting system 10 or set by the user.

In general, when the displaying module 13 of the zoom factor adjusting system 10 displays the contents zoomed image in the display area, the center of the contents zoomed image is commonly disposed at the center of the display area. In addition, one can also associate one position in the contents zoomed image to a specific position in the display area. Then the designated position in the contents zoomed image is shown at the specific position in the display area. This is more convenient.

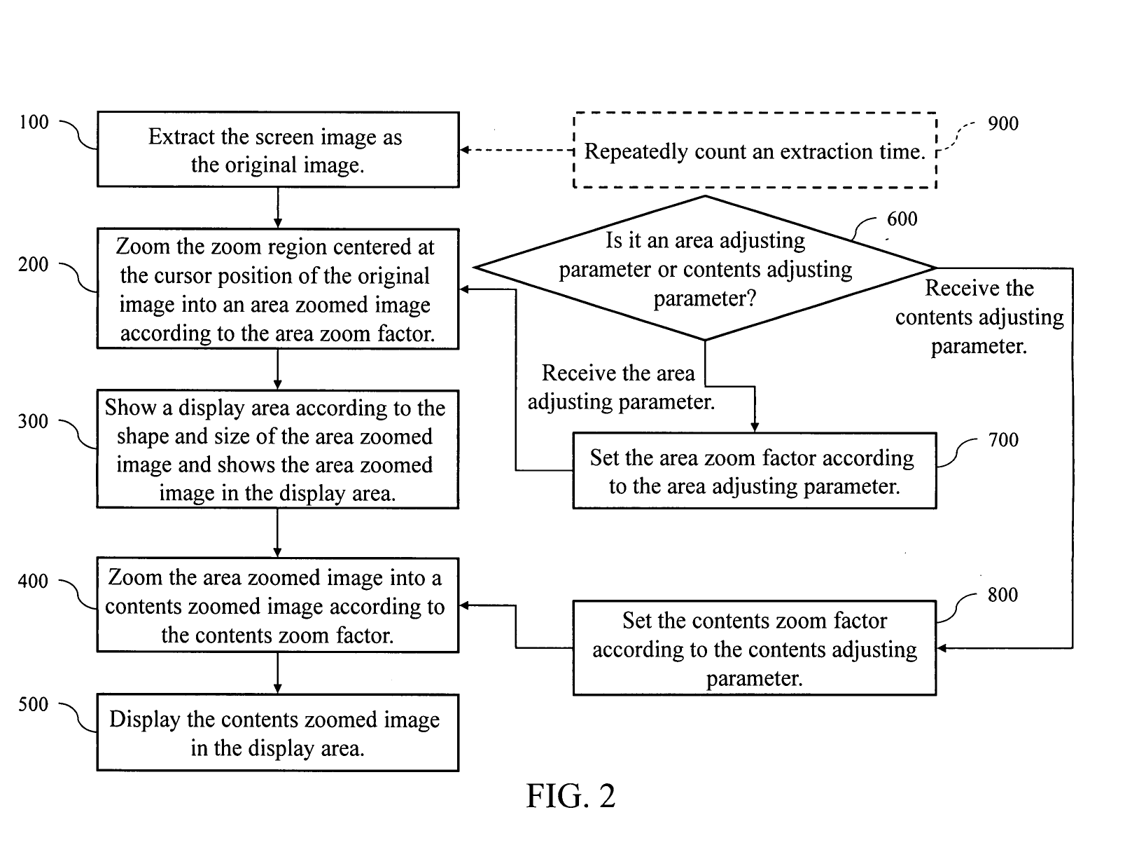

The following paragraphs use one embodiment to explain the operation and procedure of the invention. It also demonstrates the display interface of the invention. Please refer to FIGS. 1 and 2 for the description. FIG. 2 is a flowchart of the disclosed method of adjusting the zoom factors of display area and display contents.

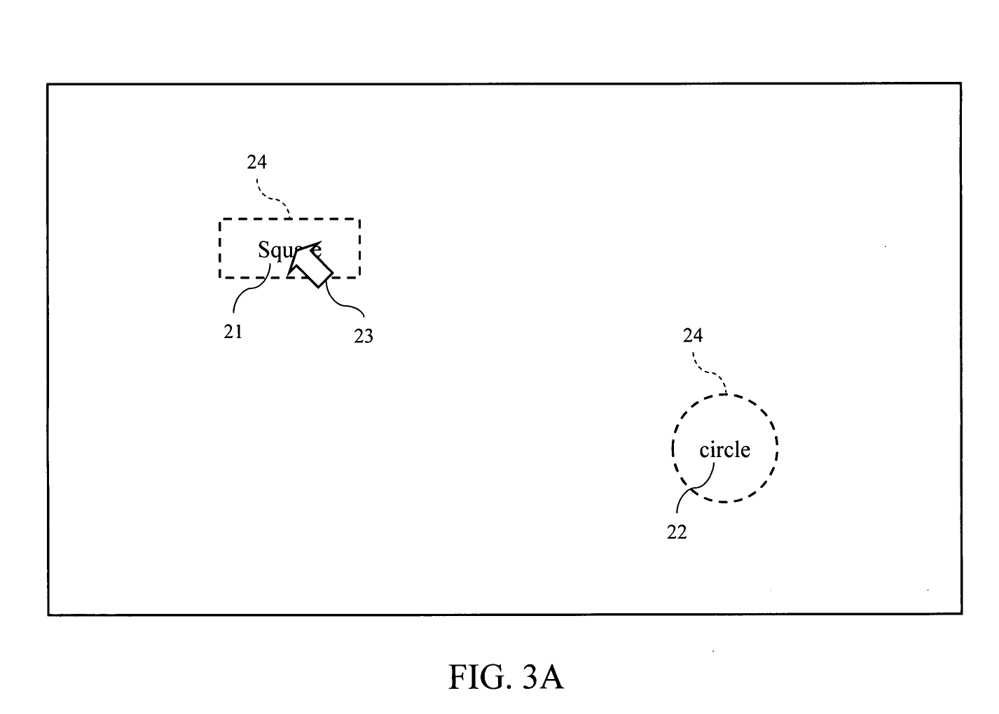

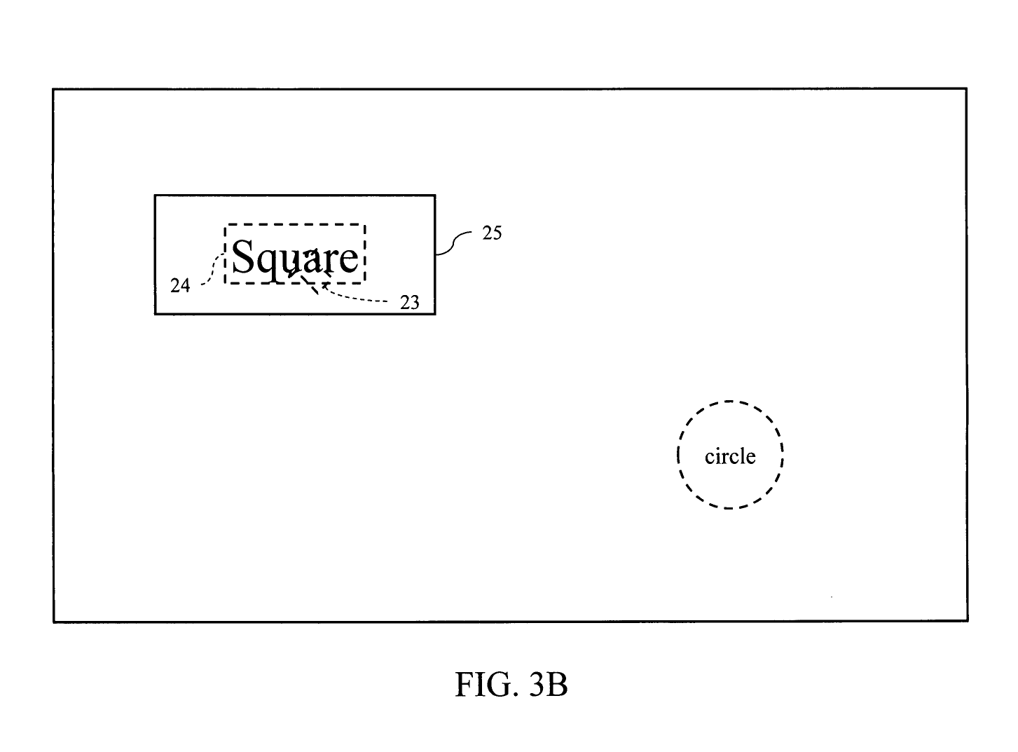

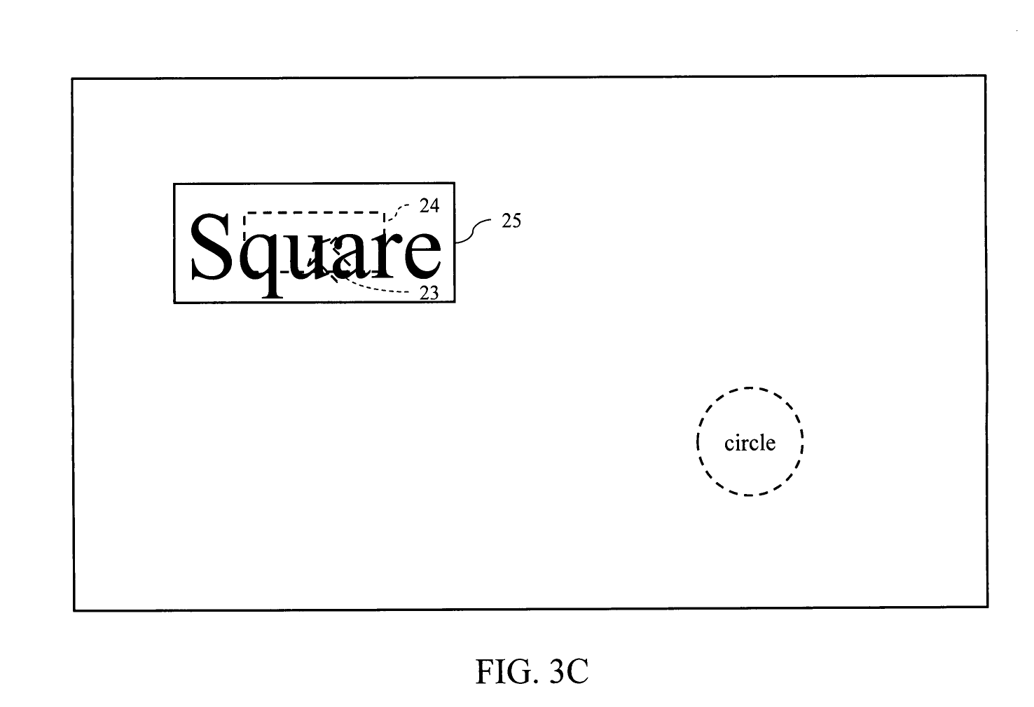

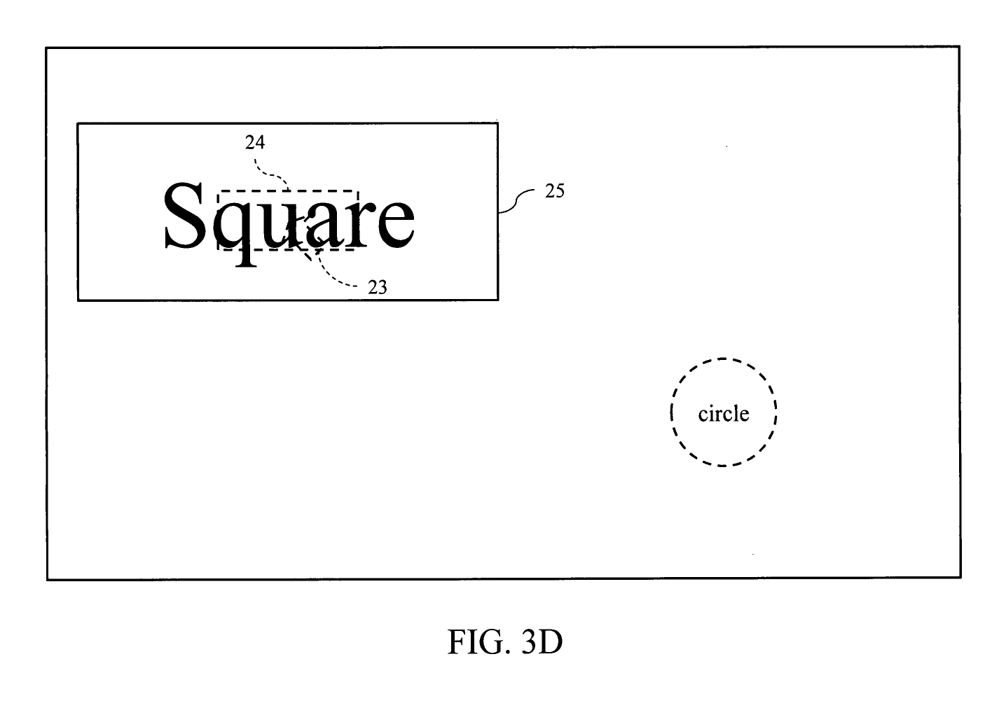

Please refer to FIG. 3A, which is a schematic view of the screen image of zoom factor adjustment according to the invention. As shown in the drawing, a first object 21 and a second object 22 are shown in the screen image. The cursor 23 is at the first object 21. The dashed line refers to the zoom region 24 predetermined by the system. The zoom region 24 can be a polygonal geometrical shape, such as rectangle, circle, etc. The zoom region at the first object 21 is predetermined to be a rectangular zoom region 24. The zoom region at the second object 22 is predetermined to be a circular zoom region 24. The shape of the zoom region 24 can also be predetermined by the zoom factor adjusting system 10 or set by the user. For example, the zoom region 24 of the first object 21 can be a circular zoom region 24, and the zoom region 24 of the second object 22 can be a rectangular zoom region 24. The following example assumes that the zoom region 24 is rectangular, but should not be used to restrict the scope of the invention. In fact, the zoom region can have any polygonal shape. The size of the zoom region 24 can be predetermined by the zoom factor adjusting system 10 or set by the user. In other words, the size of the zoom region 24 is adjustable.

Please refer to FIG. 3B, which is a schematic view of the display area of the disclosed zoom factor adjusting system. When the invention starts, the zoom factor adjusting system 10 first uses the extracting module 11 to extract the screen image as the original image. That is, the screen image in FIG. 3A is extracted as the original image (step 100).

Afterwards, the zooming module 12 of the zoom factor adjusting system 10 finds the position of the cursor 23 in the original image. The cursor position in the original image is then taken as the center to obtain the zoom region 24. Here the area zoom factor of the system is assumed to be “2”. The zooming module 12 thus zooms the zoom region 24 into the area zoomed image according to the area zoom factor “2” (step 200).

After the zooming module 12 of the zoom factor adjusting system 10 zooms the zoom region 24 centered at the cursor position 23 according to the area zoom factor “2” into the area zoomed image, the displaying module 13 thereof shows the display area 25 according to the shape and size of the area zoomed image. It further shows the area zoomed image in the display area 25 (step 300). The display result is shown in FIG. 3B.

Besides, the default contents zoom factor of the system is assumed to be “1”. The zooming module 12 of the zoom factor adjusting system 10 further zooms the area zoomed image into the contents zoomed image according to the contents zoom factor (step 400). Since the contents zoom factor of the system is assumed to be “1” here, the area zoomed image is not further zoomed. Instead, they are exactly the same. The displaying module 13 of the zoom factor adjusting system 10 then shows the contents zoomed image in the display area 25 (step 500). This prevents any display difference due to the difference between the area zoomed image and the contents zoomed image.

Please refer to FIG. 3C, which is a schematic view of adjusting the zoom factor of the display contents according to the invention. When the displaying module 13 of the zoom factor adjusting system 10 shows the display area 25, the display area 25 replaces the control of the cursor 23. That is, the display area 25 moves with the mouse. Moreover, the central position of the display area 25 is the position of cursor 23. The operating functions of the mouse are temporarily disabled. They are enabled again until the zoom factor adjusting system 10 stops.

At this moment, since the operating functions of the mouse are temporarily disabled, the user cannot perform any mouse operation. Suppose specific operation events of setting contents adjusting parameter predetermined by the system are keyboard key combinations “Ctrl+Alt+↑” and “Ctrl+Alt+↓”. The keyboard key combination “Ctrl+Alt+↑” means that the contents adjusting parameter should be increased by “1”. The contents adjusting parameter is predetermined to be the same as the contents zoom factor. The keyboard key combination “Ctrl+Alt+↓.” means that the contents adjusting parameter should be decreased by “1”.

When the user presses the keyboard key combination “Ctrl+Alt+↑”, the system determines that the contents adjusting parameter should be increased by “1”. Since the contents adjusting parameter is set to be the same as the contents zoom factor in the beginning, it is increased from “1” to “2”. The receiving module 14 of the zoom factor adjusting system 10 receives the contents adjusting parameter “2” (step 600).

Afterwards, the adjusting module 15 of the zoom factor adjusting system 10 resets the contents zoom factor as “2” according to the contents adjusting parameter “2” received by the receiving module 14 of the zoom factor adjusting system 10 (step 800).

In this case, since the contents zoom factor is reset as “2”, the zooming module 12 of the zoom factor adjusting system 10 zooms the area zoomed image into a new contents zoomed image according to the newly set contents zoom factor “2” (step 400). The displaying module 13 of the zoom factor adjusting system 10 shows the contents zoomed image in the display area 25 (step 500). The result is shown in FIG. 3C. This achieves the effect of adjusting the zoom of the display contents.

Please refer to FIG. 3D, which is a schematic view of adjusting the zoom factor of the display area according to the invention. Suppose specific operation events of setting contents adjusting parameter predetermined by the system are keyboard key combinations “Ctrl+Alt+→” and “Ctrl+Alt+←”. The keyboard key combination “Ctrl+Alt+→” means that the area adjusting parameter should be increased by “1”. The area adjusting parameter is predetermined to be the same as the area zoom factor. The keyboard key combination “Ctrl+Alt+←” means that the area adjusting parameter should be decreased by “1”.

When the user presses the keyboard key combination “Ctrl+Alt+→”, the system determines that the area adjusting parameter should be increased by “1”. Since the area adjusting parameter is set to be the same as the area zoom factor “2” in the beginning, it is increased from “2” to “3”. The receiving module 14 of the zoom factor adjusting system 10 receives the area adjusting parameter “3” (step 600).

Afterwards, the adjusting module 15 of the zoom factor adjusting system 10 resets the area zoom factor as “3” according to the area adjusting parameter “3” received by the receiving module 14 of the zoom factor adjusting system 10 (step 700).

In this case, since the area zoom factor is reset as “3”, the zooming module 12 of the zoom factor adjusting system 10 zooms the zoom region 24 centered at the cursor position of the original image into a new area zoomed image according to the newly set area zoom factor “3” (step 200). The displaying module 13 of the zoom factor adjusting system 10 shows the display region according to the shape and size of the area zoomed image. It further shows the area zoomed image in the display area 25 (step 300). The result is shown in FIG. 3D. This achieves the effect of adjusting the zoom of the display area.

Generally speaking, when the displaying module 13 of the zoom factor adjusting system 10 shows the contents zoomed image in the display area 25, the center of the contents zoomed image is commonly shown at the center of the display area 25. However, one may also assign one position in the contents zoomed image to be displayed at a specific position in the display area 25. The designated position of the contents zoomed image is then displayed at the specific position in the display area 25. The invention is thus more convenient for users.

The display method of showing the center of the contents zoomed image at the center of the display area 25 as described above is only one example, and should not be used to restrict the scope of the invention.

Besides, the invention can use the zoom factor adjusting system 10 to repeatedly count the extraction time (step 900). When the timing module 16 of the zoom factor adjusting system 10 counts one extraction time, the extracting module 11, the zooming module 12, and the displaying module 13 of the zoom factor adjusting system 10 re-execute their jobs. That is, the screen image is extracted again as the original image. A new area zoomed image or contents zoomed image is then obtained and displayed.

With a shorter extraction time interval used by the timing module 16 of the zoom factor adjusting system 10, the area zoomed image or contents zoomed image obtained by the zoom factor adjusting system 10 can be updated more frequently. The extraction time can be predetermined by the zoom factor adjusting system 10 or set by the user.

In summary, the invention first zooms the zoom region centered at the cursor position in the original image into the area zoomed image according to an area zoom factor. The area zoomed image is then zoomed into the contents zoomed image according to the contents zoom factor. The display area is adjusted in real according to the area zoom factor. Moreover, the display contents are adjusted according to the contents zoom factor. Therefore, the invention is superior to the prior art by providing comprehensive zoom functions for the display area and display contents.

The disclosed technique can solve the problems in the prior art that the display area and display contents cannot be zoomed. It achieves the goals of adjusting the zooms of display area and display contents simultaneously.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system that adjusts the zoom factors of display area and display contents, comprising:
an extracting module, which extracts the screen image as an original image;
a zooming module, which zooms a zoom region centered at the cursor position in the original image into an area zoomed image according to an area zoom factor and zooms the area zoomed image into a contents zoomed image according to a contents zoom factor;
a displaying module, which shows a display area according to the shape and size of the area zoomed image, displays the area zoomed image in the display area, and displays the contents zoomed image in the display area;
a receiving module, which receives an area adjusting parameter or contents adjusting parameter; and
an adjusting module, which adjusts the area zoom factor according to the received area adjusting parameter or the contents zoom factor according to the received contents adjusting parameter.

2. The system that adjusts the zoom factors of display area and display contents according to claim 1, wherein the size of the zoom region is predetermined by the system or set by the user.

3. The system that adjusts the zoom factors of display area and display contents according to claim 1, wherein the displaying area replaces the cursor control.

4. The system that adjusts the zoom factors of display area and display contents according to claim 1 further comprising a timing module, which repeatedly counts an extraction time and the extracting module, the zooming module, and the displaying module re-execute each time the extraction time is counted.

5. The system that adjusts the zoom factors of display area and display contents according to claim 4, wherein the extraction time is predetermined by the system or set by the user.

6. The system that adjusts the zoom factors of display area and display contents according to claim 1, wherein the area adjusting parameter and the contents adjusting parameter are set by a keyboard key event, keyboard key combination event, mouse key combination event, or keyboard mouse key combination event.

7. The system that adjusts the zoom factors of display area and display contents according to claim 6, wherein the keyboard key event, the keyboard key combination event, the mouse key combination event, or the keyboard mouse key combination event are a key or key combination event predetermined by the system or set by the user.

8. The system that adjusts the zoom factors of display area and display contents according to claim 1, wherein displaying the contents zoomed image in the display area is the center of the contents zoomed image is shown at the center of the display area.

9. The system that adjusts the zoom factors of display area and display contents according to claim 1, wherein displaying the contents zoomed image in the display area is the contents zoomed image is displayed in the display area with a designated position therein shown at a specific position in the display area.

10. A method that adjusts the zoom factors of display area and display contents, comprising the steps of:
extracting the screen image as an original image;
zooming a zoom region centered at the cursor position of the original image into an area zoomed image according to an area zoom factor;
showing a display area according to the shape and size of the area zoomed image and showing the area zoomed image in the display area;
zooming the area zoomed image into a contents zoomed image according to a contents zoom factor;
showing the contents zoomed image in the display area;
receiving an area adjusting parameter or a contents adjusting parameter;
adjusting the area zoom factor according to the area adjusting parameter; and
adjusting the contents zoom factor according to the contents adjusting parameter.

11. The method that adjusts the zoom factors of display area and display contents according to claim 10, wherein the size of the zoom region is predetermined by the system or set by the user.

12. The method that adjusts the zoom factors of display area and display contents according to claim 10, wherein the displaying area replaces the cursor control.

13. The method that adjusts the zoom factors of display area and display contents according to claim 10 further comprising the step of repeatedly counting an extraction time and the first to fifth steps are re-executed each time the extraction time is counted.

14. The method that adjusts the zoom factors of display area and display contents according to claim 13, wherein the extraction time is predetermined by the system or set by the user.

15. The method that adjusts the zoom factors of display area and display contents according to claim 10, wherein the area adjusting parameter and the contents adjusting parameter are set by a keyboard key event, keyboard key combination event, mouse key combination event, or keyboard mouse key combination event.

16. The method that adjusts the zoom factors of display area and display contents according to claim 15, wherein the keyboard key event, the keyboard key combination event, the mouse key combination event, or the keyboard mouse key combination event are a key or key combination event predetermined by the system or set by the user.

17. The method that adjusts the zoom factors of display area and display contents according to claim 10, wherein the step of showing the contents zoomed image in the display area is in the display area puts the center of the contents zoomed image at the center of the display area.

18. The method that adjusts the zoom factors of display area and display contents according to claim 10, wherein the step of showing the contents zoomed image in the display area is in the display area shows a designated position therein at a specific position in the display area.
